(19) United States
(12) Patent Application Publication
(10) Pub. No.: US 2010/0046412 A1
(43) Pub. Date: Feb. 25, 2010

(54) REFERENCE SIGNAL STRUCTURES FOR MORE THAN FOUR ANTENNAS

(75) Inventors: Badri Varadarajan, Dallas, TX (US); Eko N. Onggosanusi, Allen, TX (US); Anand G. Dabak, Plano, TX (US); Runhua Chen, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/546,615

(22) Filed: Aug. 24, 2009

Related U.S. Application Data
(60) Provisional application No. 61/091,019, filed on Aug. 22, 2008.
(60) Provisional application No. 61/096,626, filed on Sep. 12, 2008.
(60) Provisional application No. 61/099,105, filed on Sep. 22, 2008.

(51) Int. Cl. H04H 20/71; H04M 3/00; H04B 7/02

(52) U.S. Cl. 370/312; 455/418; 455/101

(57) ABSTRACT

A transmitter, for use with a cellular communication network, includes a reference signal generation unit configured to provide a reference signal corresponding to a reference signal structure for more than four transmit antennas. The transmitter also includes a system information signal generation unit configured to provide a system information signal corresponding to the reference signal structure for the more than four transmit antennas. The transmitter additionally includes a transmit unit configured to transmit the reference signal and the system information signal.

### CROSS-REFERENCE TO PROVISIONAL APPLICATIONS

This application claims the benefit of U.S. Provisional Application No. 61/091,019, filed by Eko N. Onggosanusi, Badri Varadarajan, Anand G. Dabak and Runhua Chen on Aug. 22, 2008, entitled “Reference Signal Structures for More Than Four Antennas” commonly assigned with this application and incorporated herein by reference.

This application also claims the benefit of U.S. Provisional Application No. 61/096,626, filed by Eko N. Onggosanusi, Badri Varadarajan, Anand G. Dabak and Runhua Chen on Sep. 12, 2008, entitled “Reference Signal Structures for More Than Four Antennas” commonly assigned with this application and incorporated herein by reference.

This application additionally claims the benefit of U.S. Provisional Application No. 61/099,105, filed by Eko N. Onggosanusi, Badri Varadarajan, Anand G. Dabak and Runhua Chen on Sep. 22, 2008, entitled “Reference Signal Structures for More Than Four Antennas” commonly assigned with this application and incorporated herein by reference.

### TECHNICAL FIELD

The present disclosure is directed, in general, to a communications system and, more specifically, to a transmitter, a receiver and methods of operating a transmitter and a receiver.

### BACKGROUND

In a cellular network such as one employing orthogonal frequency division multiple access (OFDMA), each communication cell employs a base station that communicates with user equipment. MIMO communication systems offer increases in throughput due to their ability to support multiple parallel data streams that are each transmitted from different antennas. These systems provide increased data rates and reliability by exploiting spatial multiplexing gain or spatial diversity gain that is available to MIMO channels. Although current data rates are adequate, improvements in data rate capability would prove beneficial in the art.

### SUMMARY

Embodiments of the present disclosure provide a transmitter, a receiver and methods of operating a transmitter and a receiver. In one embodiment, the transmitter is for use with a cellular communication network and includes a reference signal generation unit configured to provide a reference signal corresponding to a reference signal structure for more than four transmit antennas. The transmitter also includes a system information signal generation unit configured to provide a system information signal corresponding to the reference signal structure for the more than four transmit antennas. The transmitter additionally includes a transmit unit configured to transmit the reference signal and the system information signal. In another embodiment, the receiver is for use with a cellular communication network and includes a receive unit configured to receive a reference signal and a system information signal. The receiver also includes a reference signal decoding unit configured to decode the reference signal based on a reference signal structure for more than four transmit antennas. The receiver further includes a system information signal decoding unit configured to decode the system information signal based on the reference signal structure for the more than four transmit antennas.

In another aspect, the method of operating a transmitter is for use with a cellular communication network and includes providing a reference signal corresponding to a reference signal structure for more than four transmit antennas and providing a system information signal corresponding to the reference signal structure for the more than four transmit antennas. The method also includes transmitting the reference signal and the system information signal. In yet another aspect, the method of operating a receiver is for use with a cellular communication network and includes receiving a reference signal and a system information signal. The method also includes decoding the reference signal based on a reference signal structure for more than four transmit antennas and decoding the system information signal based on the reference signal structure for the more than four transmit antennas.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIGS. 1A and 1B illustrate a cell-specific (common) reference signal structure for up to four transmit antennas employing normal and long CP modes;

FIG. 2 illustrates an exemplary diagram of a cellular communication network employing embodiments of a transmitter and a receiver constructed according to the principles of the present disclosure;

FIGS. 3A and 3B illustrate an example of time-frequency patterns showing reference signal structures for time division multiplexing (TDM) of antenna ports within an antenna pair;

FIG. 4 illustrates an example of channel estimate separation between two antenna ports constructed according to the principles of the present disclosure;

FIGS. 5A and 5B illustrate time-frequency transmission patterns showing reference signal structures that affect reference signal resources allocated to antenna ports 0-3;

FIG. 6 illustrates a collection of subframes as may be employed by a transmitter and a receiver in a cellular communication system such as the base station transmitter and the user equipment receiver of FIG. 2.

FIG. 7 illustrates a flow diagram of an embodiment of a method of operating a transmitter carried out according to the principles of the present disclosure; and

FIG. 8 illustrates a flow diagram of an embodiment of a method of operating a receiver carried out according to the principles of the present disclosure.

### DETAILED DESCRIPTION

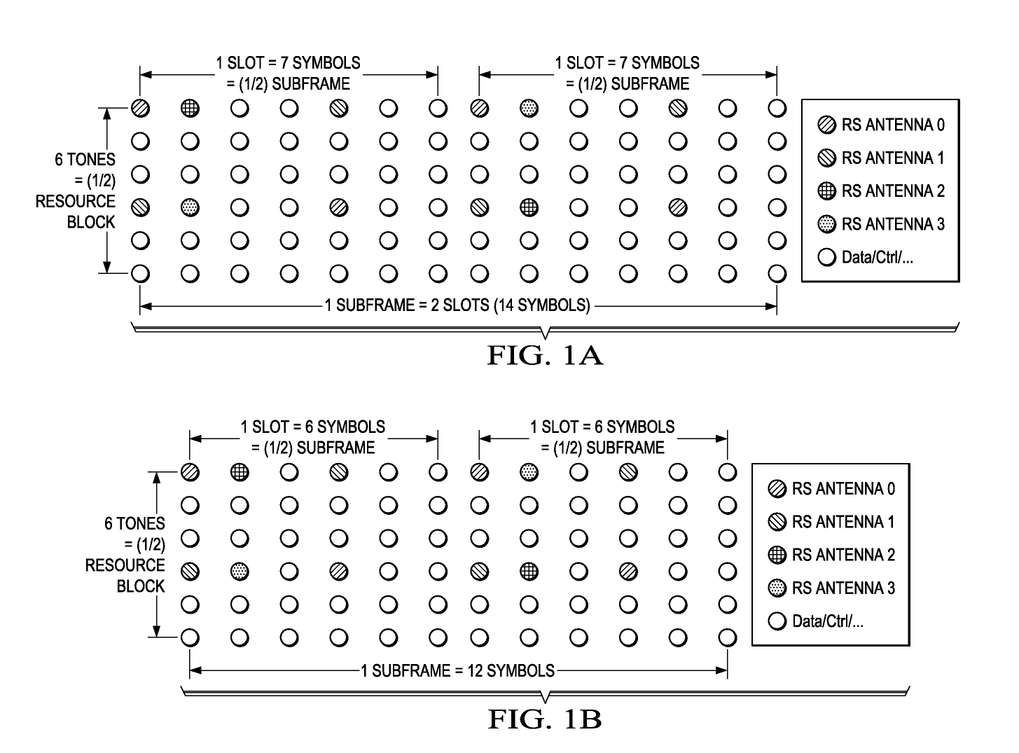

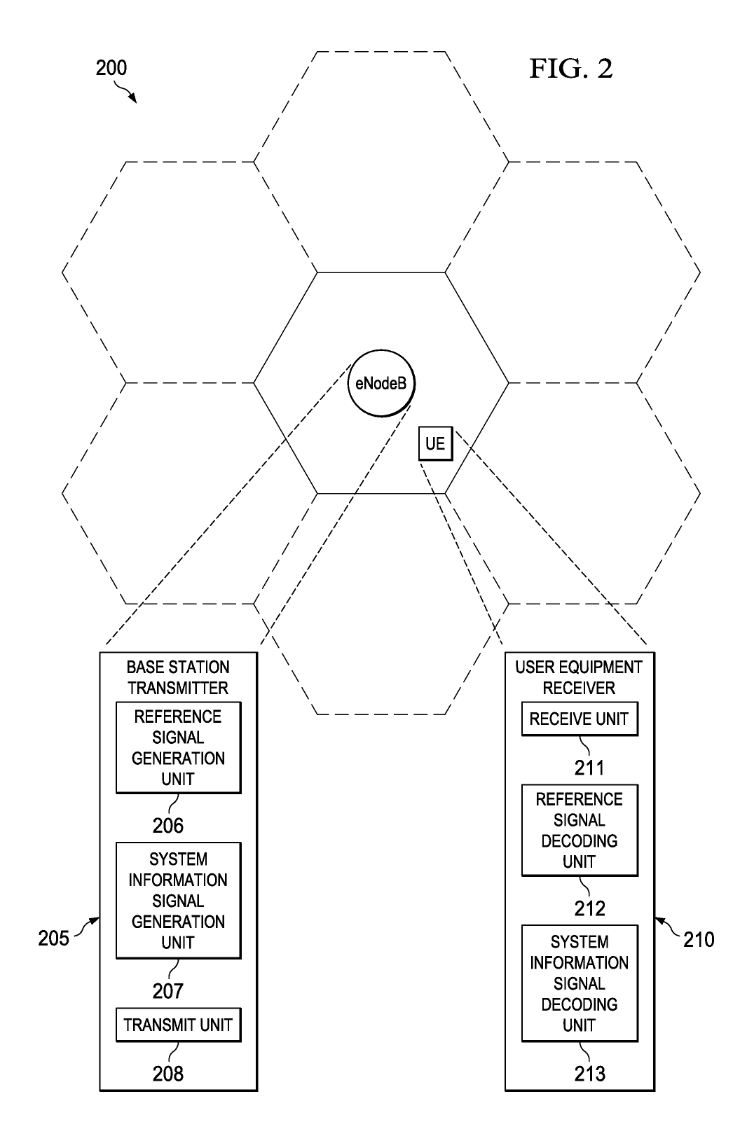

The current Long Term Evolution (LTE) associated with the Evolved UMTS Terrestrial Radio Access Network (E-UTRA) specification (LTE Release 8) supports up to four layers of spatial multiplexing. FIGS. 1A and 1B illustrate a cell-specific (common) reference signal structure for up to four transmit antennas employing normal and long CP modes, respectively. As shown, reference signal resources are allocated for up to four corresponding antenna ports.

For each antenna port, the reference signals are carried in only Kₜ OFDM symbols of the fourteen available in the normal mode of FIG. 1A (or the twelve available in the long CP mode of FIG. 1B) in each subframe. As may be seen, for antenna ports 0 and 1, Kₜ is equal to four. For antenna ports 2 and 3, Kₜ is equal to two. In any reference signal symbol, every sixth sub-carrier carries a reference signal. In the next reference signal symbol for the same antenna port, the reference signal sub-carriers are shifted in frequency. Thus, after time interpolation, the reference signals are available on every third sub-carrier for each antenna port.

Enhancements associated with the LTE of the E-UTRA continue to drive the need for improvements and upgrades in cellular technology. Of particular interest is an increase in the downlink (DL) peak data rate by a factor of two as well as an increase in the DL spectral efficiency to meet International Mobile Telecommunication (IMT) Advanced requirements. Additionally, it is also desirable to keep the reference signal overhead low (i.e., the fraction of time-frequency resources that are used for reference signals). Since 64QAM is already supported for the current E-UTRA and higher-order modulation is infeasible in terms of error vector magnitude (EVM) requirements, the use of more transmit antennas at a base station is attractive.

To enable channel estimation, reference signals are transmitted from each of the transmit antenna ports, as indicated above. Therefore, a transmitter employing as many as eight transmit antennas and user equipment (UE) employing R receive antennas requires using an effective channel matrix having up to eight times R (8×R) matrix elements. Embodiments of this disclosure provide reference signal structures for Nₜ transmit antenna ports, where Nₜ is greater than four.

FIG. 2 illustrates an exemplary diagram of a cellular communication network 200 employing embodiments of a transmitter and a receiver constructed according to the principles of the present disclosure. In the illustrated embodiment, the cellular communication network 200 is part of an OFDM system and includes a cellular grid having a centric cell and six surrounding first-tier cells. The centric cell employs a centric base station eNodeB that includes a base station transmitter 205. The base station transmitter 205 includes a reference signal generation unit 206; a system information signal generation unit 207 and a transmit unit 208. User equipment (UE) is located in the centric cell, as shown. The UE includes a receiver 210 having a receive unit 211, a reference signal decoding unit 212 and a system information signal decoding unit 213.

In the base station transmitter 205, the reference signal generation unit 206 is configured to provide a reference signal corresponding to a reference signal structure for more than four transmit antennas. The system information signal generation unit 207 is configured to provide a system information signal corresponding to the reference signal structure for the more than four transmit antennas. Correspondingly, the transmit unit 208 is configured to transmit the reference signal and the system information signal.

In the UE receiver 210, the receive unit 211 is configured to receive a reference signal and a system information signal. The reference signal decoding unit 212 is configured to decode the reference signal based on a reference signal structure for more than four transmit antennas. The system information signal decoding unit 213 is configured to decode the system information signal based on the reference signal structure for the more than four transmit antennas.

The reference signals may correspond to a unicast subframe, a multicast subframe and an advanced unicast subframe. A unicast subframe may be employed by a UE that accommodates up to four transmit antennas (i.e., conforms to the LTE Release 8 specification, for example). An advanced unicast subframe may be employed by a UE that accommodates up to eight transmit antennas (i.e., conforms to an LTE release 10 specification, for example). An example of a multicast subframe is an MBSFN (multimedia broadcast over a single frequency network) subframe.

Reference signal structures employing the same overhead as current four antenna port transmitters are considered first. Such designs are backward compatible with current two transmit antenna and four transmit antenna transmissions. They typically do not result in a specification change for other system components (e.g., control channel resource definition or collision with synchronization signals, for example). In particular, a UE that does not support an eight transmit antenna transmission, for example, may still receive a two transmit antenna or four transmit antenna transmission if the eNodeB performs antenna port combining.

For an application employing eight transmit antennas, the current frequency density may remain unchanged to provide a desired channel length support. Also, if an eight antenna port transmission, for example, is intended primarily for low-mobility users, the time density may be reduced without significantly affecting performance. Additionally, a total cell-specific reference signal power may be adjusted to ensure the same transmission coverage. This may be used as a basis for reference signal structures as addressed below. In this sense, the reference signal time and frequency resources employed may generally remain the same as for current applications.

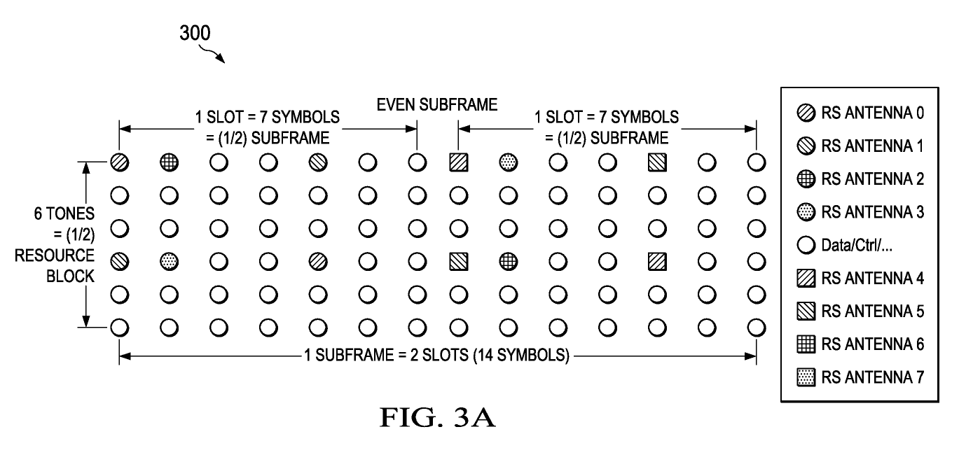

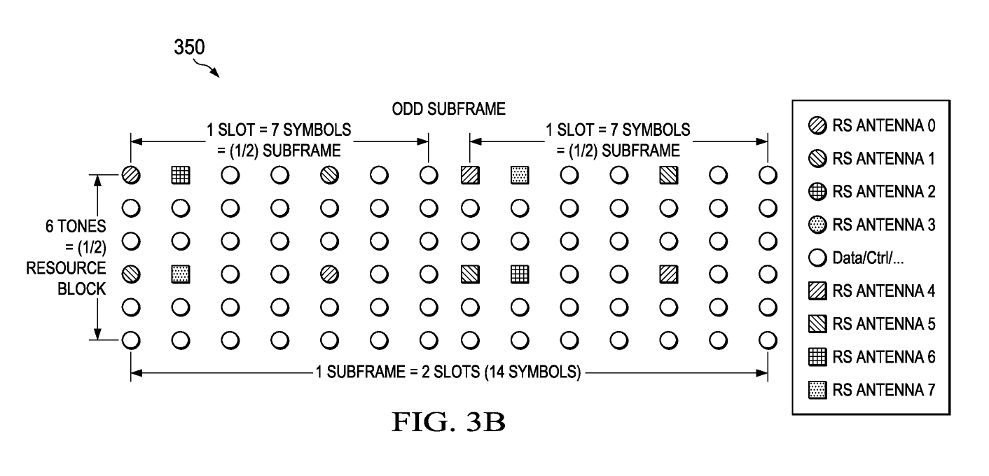

For time division multiplexing of antenna ports, the available antenna ports may be divided into pairs. FIGS. 3A and 3B illustrate an example of time-frequency patterns 300, 350 showing reference signal structures for time division multiplexing (TDM) of antenna ports within an antenna pair.

FIGS. 3A and 3B show an exemplary pairing for the case of eight transmit antenna ports (Nₜ=8) having port pairs {(0,4), (1,5), (2,6), (3,7)}. Of course, other port pairings are possible. Each pair shares the frequency resources for a reference signal transmission by time multiplexing. Thus, in a given pair, only one of the transmit antenna ports uses the reference signal sub-carriers for a given reference symbol.

Consider, for example, a current reference signal structure (e.g., FIGS. 1A, 1B) for antenna port 0 wherein there are four reference symbols in one subframe, and the signal phases alternate between phase one and phase two (i.e., phase two is shifted from phase one by three sub-carriers). In the paired structure of FIGS. 3A and 3B, the following transmissions employing four OFDM symbols may be used wherein the structure repeats every subframe. A first transmission employing antenna port 0, phase 1; antenna port 0, phase 2; antenna port 4, phase 1 and antenna port 4, phase 2 may be used. A second transmission employing antenna port 0, phase 1; antenna port 4, phase 2; antenna port 4, phase 1 and antenna port 0, phase 2 may also be used.

A similar approach may be employed between antenna ports 1 and 5. For example, a first transmission employing antenna port 1, phase 2; antenna port 1, phase 1; antenna port 5, phase 2 and antenna port 5, phase 1 may be used. A second transmission employing antenna port 1, phase 2; antenna port 5, phase 1; antenna port 5, phase 1 and antenna port 1, phase 2 may also be used.

Antenna ports 3 and 4 are of particular interest. Note that currently, there are only two reference signal symbols for these antenna ports, employing, for example, antenna port 3, phase 1 and antenna port 3, phase 2. In this case, there is no room for TDM within one subframe. Consequently, alternate subframes may be used for each antenna port in an antenna port pair. For instance, subframes 0, 2, 4, 6 and 8 carry antenna port 3, phase 1 and antenna port 3, phase 2 while subframes 1, 3, and 7 carry antenna port 7, phase 1 and antenna port 7, phase 2.

Alternatively, it is also possible to reduce the reference signal frequency density for antenna ports 2, 3, 6, and 7 to ensure that the reference signals for all eight antenna ports are contained within each subframe. For this case, the reference signals in the second OFDM symbol (out of four OFDM symbols containing reference signals) are shared between antenna ports 2 and 3. Similarly, the reference signals in the fourth OFDM symbol (out of four OFDM symbols containing reference signals) are shared between antenna ports 6 and 7. Hence, intra-subframe time interpolation to increase the effective frequency density is not possible for antenna ports 2, 3, 6, and 7. This pattern may be repeated across a subframe.

Furthermore, it is also possible to allow inter-subframe time interpolation gain (for increasing the effective frequency density) by interchanging or alternating the phase assignment for antenna ports 2, 3, 6, and 7 across subframes. For example, phase assignments across the four OFDM symbols containing reference signals for antenna ports 2, 3, 6, and 7 for even subframes may be none; antenna port 2, phase 1; none, antenna port 6, phase 1 and none; antenna port 3, phase 2; none, and antenna port 7, phase 2: For odd subframes, they may be none; antenna port 2, phase 2; none and antenna port 6, phase 2; none, antenna port 3, phase 1; none and antenna port 7, phase 1. Antenna ports 0, 1, 4, and 5 may be similarly accommodated.

It may also be noted that not all antenna ports need to be paired. For example, if there are only six antenna ports (Nₜ=6), then the following set of antenna ports {(0,4), (1,5), (2), (3)} may be employed wherein the unpaired antenna ports 2 and 3 may use an existing LTE reference signal structure. Of course, the alternate-subframe TDM method described above may also be employed for the set of antenna ports {0, 1, (2,4), (3,5)}, for example.

To ensure that a design is backward compatible and allows the eNodeB to support UEs with different capabilities (in terms of the number of received layers), antenna port combining may be performed at the eNodeB between the paired antenna ports. Port combining may be accomplished simply by replicating the transmitted signal across the paired antenna ports in a manner that is transparent to the UE. An additional delay may be introduced for replication of the transmitted signal to increase frequency diversity.

Following the approach discussed above and using code division multiplexing (CDM) of antenna ports over time, it is also possible to multiplex antennas ports using CDM or sequences across the paired antenna ports. That is, the reference signals associated with the paired antenna ports may share the same time and frequency resources but are differentiated with different codes or sequences, instead of being time-multiplexed. In this case, two codes are needed to differentiate the two antenna ports. The two codes may be orthogonal or non-orthogonal, but orthogonal codes may be generally preferred.

Considering CDM employing orthogonal codes, for example, the antenna pair (0,4) may transmit reference signals on the same time-frequency resources. For convenience, denote X(k, l, m) as the quantity transmitted by antenna port k on reference signal symbol l and resource element (sub-carrier) m. Then, CDM achieves multiplexing by ensuring that for antenna port pairs (k1,k2) the relation shown in equation (1) below is true.

X(k1,l,m)□X*(k2,l,m)+X(k2,l+2,m)□X*(k1,l+2,m)=0. (1)

With time interpolation over an even number of symbols (assuming low Doppler distortion), a receiver can separate channel estimates from antenna ports k1 and k2. The same may be calculated for the antenna pair (1,5).

To support the reference signal multiplexing for antenna pairs (2,6) and (3,7), two possibilities apply as with the TDM examples discussed previously. A first approach includes alternating between antenna ports 2 and 6 (as well as 3 and 7) across subframes while maintaining the same reference signal frequency density. A second approach includes alternating the phase assignment across subframes while ensuring that all the reference signals for the eight antenna ports are contained within each subframe and reducing the reference signal frequency density.

For CDM multiplexing of antenna ports over frequency, different antenna ports in the same pair are multiplexed by putting a phase ramp on one of the antenna ports, which effectively makes the channel appear to have a different delay spread. The advantage of this approach is that it can be used even for antenna port pairs (2,6) and (3,7) to keep all the reference signals within the same subframe. This approach is described more precisely below.

A reference signal transmitted by antenna port k on reference signal symbol l and resource element (sub-carrier) m satisfies equation (2) below.

X(k2,l,m)=exp(j2πD/N)*X(k1,l,m), (2)

where D is the separation in time (samples) desired in the channel lengths. Typically, D=N/3 may be used to separate two pairs.

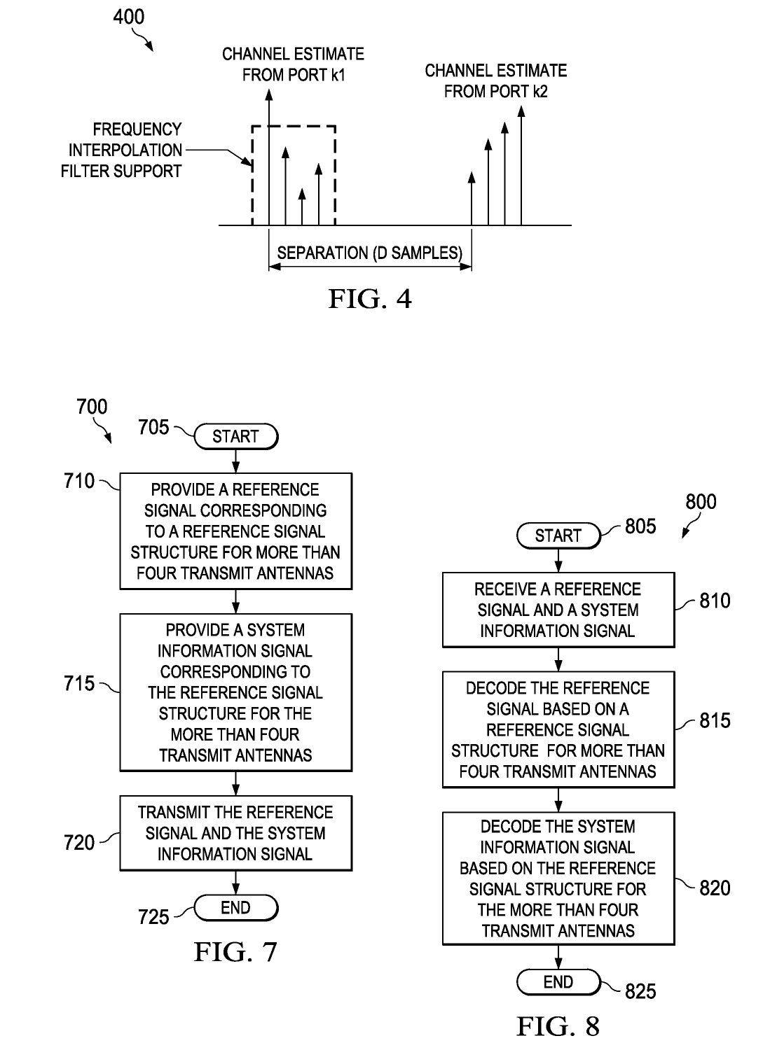

FIG. 4 illustrates an example 400 of channel estimate separation between two antenna ports constructed according to the principles of the present disclosure. After dispreading by the pilot sequence of antenna port k1, there is a time separation between the effective channels from antenna port k1 and k2. The “interference” from the pilot sequences of antenna port k2 is removed by standard frequency interpolation, as seen in FIG. 4.

An advantage of this approach is that there is no additional overhead, and the multiplexing of antenna port k2 is completely transparent to a UE operating under the LTE Release 8 specification, for example. However, though the channel estimates for antenna port k1 are accurate, the reference signals from antenna port k2 will be seen as noise. If the UE is not aware of this fact, pilot-based noise variance estimation (NVE) will overestimate the noise variance. Therefore, some signaling to let the UE know about the presence of the reference signal from antenna port k2 may be necessary. In other words, the multiplexing described above may be added without changes to current LTE standards. Such a change will not affect the accuracy of channel estimates, but it may affect the accuracy of noise variance estimation without additional signaling support.

A combination of the above schemes is also possible. For example, CDM in time and frequency may be combined. The reference signal for antenna pairs (0,4) and (1,5) may be multiplexed employing time domain CDM while the reference signal for antenna pairs (2,6) and (3,7) may be multiplexed employing frequency domain CDM. Additionally, CDM may be performed in a two dimensional manner in time and frequency. A hybrid between TDM and CDM (i.e., time and frequency domains) may be constructed as well.

Reference signal structures requiring additional overhead compared to existing four antenna reference signals (e.g., LTE Release 8) are addressed below. These structures fall into two general categories. A first category leaves the reference signal resources for antenna ports 0-3 unchanged. A second category is presented wherein reference signals for antenna ports 0-3 are affected.

Strictly backward compatible structures that do not affect antenna ports 0-3 are necessary to allow continued operation with current systems (e.g., with LTE Release 8). A future specification (e.g., an LTE Release 9 or 10) for a communication cell may have to support current systems wherein UEs that are unaware of the existence of any additional antenna ports use reference signal resources for antenna ports 0-3. These resources may include the requirement for receive signal strength measurements, noise variance estimation, channel quality indicator computation or handover measurements, for example.

To ensure that the measurement by such UEs is not compromised, it is necessary to leave reference elements for antenna ports 0-3 unchanged. This leads to employing additional resources only for antenna ports 4-7. An obvious choice in these cases is to add additional OFDM symbols to carry reference signals for antenna ports 4-7. On these symbols, the reference signal can be multiplexed by TDM, FDM or CDM. As examples, the following reference signal structures may be employed.

CDM multiplexing may use phase ramping. FDM multiplexing may be used having greater frequency spacing after time interpolation. This may be supported for the following reasons. An FFT placement can be accurately obtained by each UE using the reference signal on antenna ports 0-3. Once accurate placement is obtained, one only needs a spacing of K tones to support a channel length of N/K. For the case where channel lengths of at most N/10 (comparable to the CP) may be employed, for example, a frequency spacing of 10 tones may be sufficient. In particular, one may employ tone spacing of six tones for antenna ports 4-7 (as opposed to three tones for antenna ports 0-3. Additionally, some combination of CDM, FDM and TDM may be employed.

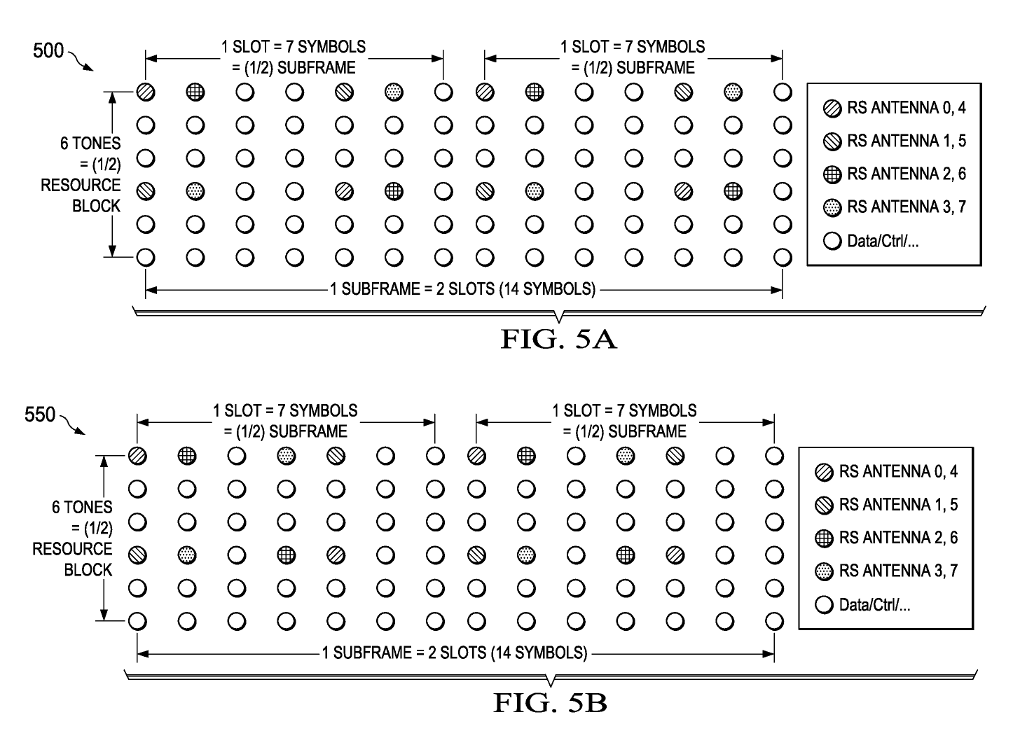

FIGS. 5A and 5B illustrate time-frequency transmission patterns 500, 550 showing reference signal structures that affect reference signal resources allocated to antenna ports 0-3. An obvious extension for eight transmit antennas, for example, is to replicate the current four antenna port reference signal structure for antenna ports 5-7. However, this involves a doubling of the reference signal overhead. An alternative possibility is to provide two additional reference signal symbols so that antenna ports 2 and 3 are now similar to antenna ports 0 and 1. In this case, the TDM or CDM embodiments described above may be extended to the new reference signal structure, while keeping all reference signals for antenna ports 2 and 3 in the current subframe. This structure 500 is shown in FIG. 5A. Here, additional reference signal symbols have been added (the sixth symbol in each slot) to accommodate reference signals for antenna port pairs (2,6) and (3,7).

An advantage of the proposed structure is that additional antennas are accommodated with small additional overhead. A disadvantage is that the reference signals in the sixth OFDM symbol collide with the primary or secondary synchronization signal twice within a radio frame. In this case, it may be advisable to insert the additional reference signal symbol in the fourth (instead of the sixth) symbol in each slot. This is shown as structure 550 in FIG. 5B.

Referring again to FIG. 2, signaling methods to support coexistence of the exemplary reference signal structures in a communication cell containing UEs operating under an existing specification (e.g., LTE Release 8) are addressed below. Since these UEs use reference signals from antenna ports 0-3 for various purposes, the following general principles may be applied for embodiments of the present disclosure. On subframes that will be used by the UEs for existing communication cells (e.g., LTE Release 8), the reference signals on antenna ports 0-3 remain unchanged. In one embodiment, additional reference signals may not be added to these resources (even if they are orthogonal to a current reference signal) on antenna ports 0-3 using some adaptation of CDM. Consequently a mechanism is needed to control which subframes are used by UEs for the existing specification (LTE Release 8).

It is proposed to accomplish this by signaling additional subframes (e.g., LTE releases 9 and 10 subframes where the reference signal on antenna ports 0-3 are affected) as MBSFN (Multimedia Broadcast over a Single Frequency Network) subframes. Consequently, these subframes may not be used by a UE employing an LTE release 8, for example. However, in the system information (SI), additional signals are transmitted to enable UEs using advanced unicast subframes (e.g., LTE Release 9 and 10 subframes) to distinguish between actual MBSFN subframes and advanced unicast subframes carrying LTE Release 9 or 10 reference signals.

On LTE Release 8 subframes, reference signals for antenna ports 0-3 are unchanged. However, additional reference signals for antenna ports 4-7 may be inserted in resource blocks where LTE Release 8 UEs are not scheduled. On unicast subframes for LTE Release 9 and 10, for example, the first two OFDM symbols carry the same reference signal structure as the corresponding symbols in an LTE Release 8 subframe, since these may be used by the LTE release 8 UE. However, subsequent symbols may have other reference signal structures, such as the ones discussed above, for example.

The use of MBSFN indication signals and additional signaling on the SI are intended to enable the following. LTE Release 8 UEs do not mistakenly use reference signal symbols in subframes intended for LTE Release 9 and 10 UEs. Additionally, the LTE Release 9 and 10 UEs are able to distinguish between LTE Release 8 unicast subframes or LTE Release 9 and 10 advanced unicast subframes and actual MBSFN subframes (multicast subframes).

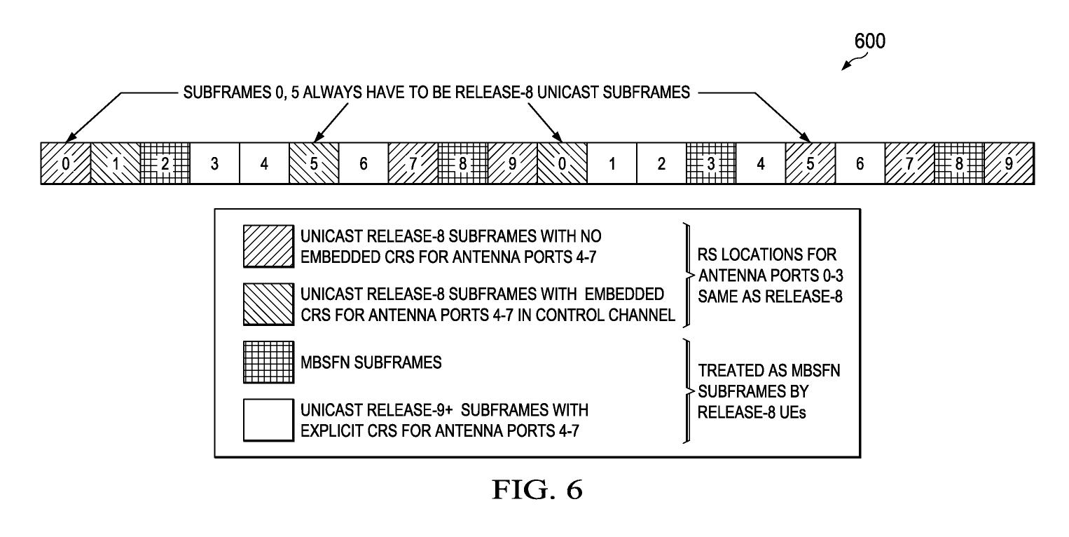

FIG. 6 illustrates a collection of subframes 600 as may be employed by a transmitter and a receiver in a cellular communication system such as the base station transmitter 205 and the user equipment receiver 210 of FIG. 2. As may be seen in FIG. 6, four types of subframes are identified. The first two subframe types can be used for unicast transmission to LTE UEs. However, one of these subframe types also supports cell-specific reference signal transmission on antenna ports 4-7, embedded in the control channel in a backward-compatible manner. The third subframe type supports unicast transmission only to LTE-Advanced (LTE-A) (LTE Release 9 and 10) UEs. The fourth subframe type supports MBSFN transmission, which UEs may choose to decode. The actions of the eNodeB, LTE Release 8 UEs and LTE-A UEs are listed for each subframe type in Table 1, below.

TABLE 1
Actions and Signaling For Each Subframe Type

| Subframe Type | eNodeB Action | Release-8 UE | LTE-A UE | Signaling |
|---|---|---|---|---|
| Unicast Release- | Backward | Treat as release-8 | Same as release-8 | Signaled as release-8 |
| 8 Subframe with | compatible | unicast subframe, | UEs | unicast UE |
| no embedded | release-8 unicast | including channel | | |
| CRS for ports 4-7 | subframe. | estimation, control | | |
| | UE-specific RS | channel decoding, | | |
| | may be added on | PDSCH decoding, | | |
| | antenna ports 4-7 | RSRP/CQI | | |
| | for LTE-A UEs, but | measurement | | |
| | only in scheduled | | | |
| | RBs | | | |
| Unicast Release- | Same as above. In | Same as above | Same as release-8 | Signaled as release-8 |
| 8-compliant | addition, some | | UE. In addition, use | unicast UE. In addition, |
| subframe with | PDCCH reserved | | embedded CRS for | special signaling for |
| embedded CRS | for CRS | | channel estimation, | LTE-A UEs to give |
| for ports 4-7 in | transmission for | | RSRP/CQI | indices of reserved |
| control channel | LTE-A UEs | | measurement on | PDCCHs |
| | | | antennas 4-7 | |
| Unicast LTE-A | Schedule only | Treat as MBSFN | Use for control | Signaled as MBSFN |
| subframes | LTE-A UEs | subframe. Only | channel, PDSCH | subframe to release-8 |
| | Explicit CRS on | decode PHICH and | decoding. Also use all | UEs. In addition, special |
| | antenna ports 4-7 | PDCCH. | CRS for channel | signaling for LTE-A UEs |
| | for LTE-A UEs | | estimation/RSRP/ | to distinguish from |
| | | | CQI measurement | MBSFN. |
| MBSFN | Unicast CRS + | Treat as MBSFN | Treat as MBSFN | Signaled as MBSFN |
| subframes | control on first few | subframe. Only | subframe. Only | subframe to release-8 |
| | symbols, MBSFN | decode PHICH and | decode PHICH and | and LTE-A UEs. |
| | on the rest | PDCCH. | PDCCH. May also | |
| | | | decode MBSFN | |

Further details on the various subframe types are provided below. First, consider LTE Release 8 unicast subframes with no reference signal for LTE-A UEs. These may be used by both LTE Release 8 and LTE-A UEs for unicast data reception. Cell-specific reference signals are transmitted on antenna ports 0-3 on the same locations as LTE Release 8 unicast subframes. The common reference signal (CRS) and control regions are the same as in the existing LTE Release 8 standard. In addition, UE-specific reference signals may be transmitted on resource blocks allocated to LTE-A UEs to support channel estimation on antenna ports 4-7 (or a subset thereof), if they are used in PDSCH transmission.

Second, consider LTE Release 8 compliant unicast subframes with embedded reference signals for LTE-A UEs. These subframes are similar to other LTE release-8 unicast subframes, except that cell-specific reference signals on antenna ports 4-7 may be embedded in the control region in a manner transparent to LTE Release 8 UEs.

Third, LTE-A unicast subframes are considered wherein these subframes contain cell-specific reference signals on antenna ports 0-7 (or a subset thereof). LTE Release 8 UEs treat these subframes in the same way they treat MBSFN subframes. That is, they may use the reference signals on the first two OFDM symbols and may attempt to decode PDCCH or PHICH in the first two symbols.

Fourth, for MBSFN subframes, these subframes contain unicast reference signals for antenna ports 0-3 and some unicast control information (e.g., PCFICH, PHICH, PDCCH) in the first two symbols along with MBSFN reference signals and data in the remaining symbols. In addition, they may also contain some embedded reference signals for antenna ports.

FIG. 7 illustrates a flow diagram of an embodiment of a method of operating a transmitter 700 carried out according to the principles of the present disclosure. The method 700 is for use with a cellular communication network and starts in a step 705. Then, in a step 710, a reference signal is provided corresponding to a reference signal structure for more than four transmit antennas.

In one embodiment, the reference signal corresponds to one selected from the group consisting of a unicast subframe, a multicast subframe and an advanced unicast subframe. In another embodiment, the reference signal distinguishes between a multicast subframe and an advanced unicast subframe. In yet another embodiment, the reference signal conforms to a reference signal structure that provides paring of select transmit antennas.

A system information signal corresponding to the reference signal structure for the more than four transmit antennas is provided in a step 715. In one embodiment, the system information signal provides an indication that distinguishes between a unicast subframe and a non-unicast subframe. The reference signal and the system information signal are transmitted in a step 720, and the method 700 ends in a step 725.

FIG. 8 illustrates a flow diagram of an embodiment of a method of operating a receiver 800 carried out according to the principles of the present disclosure. The method 800 is for use with a cellular communication network and starts in a step 805. Then, in a step 810 a reference signal and a system information signal are received. The reference signal is based on a reference signal structure for more than four transmit antennas and is decoded in a step 815.

In one embodiment, the reference signal corresponds to one selected from the group consisting of a unicast subframe, a multicast subframe and an advanced unicast subframe. In another embodiment, the reference signal distinguishes between a multicast subframe and an advanced unicast subframe. In yet another embodiment, the reference signal conforms to a reference signal structure that provides paring of select transmit antennas.

The system information signal is based on the reference signal structure for the more than four transmit antennas and is decoded in a step 820. In one embodiment, the system information signal provides an indication that distinguishes between a unicast subframe and a non-unicast subframe. The method 800 ends in a step 825.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A transmitter for use with a cellular communication network, comprising:
a reference signal generation unit configured to provide a reference signal corresponding to a reference signal structure for more than four transmit antennas;
a system information signal generation unit configured to provide a system information signal corresponding to the reference signal structure for the more than four transmit antennas; and
a transmit unit configured to transmit the reference signal and the system information signal.

2. The transmitter as recited in claim 1 wherein the reference signal corresponds to one selected from the group consisting of:
a unicast subframe;
a multicast subframe; and
an advanced unicast subframe.

3. The transmitter as recited in claim 1 wherein the reference signal distinguishes between a multicast subframe and an advanced unicast subframe.

4. The transmitter as recited in claim 1 wherein the reference signal conforms to a reference signal structure that provides paring of select transmit antennas.

5. The transmitter as recited in claim 1 wherein the system information signal provides an indication that distinguishes between a unicast subframe and a non-unicast subframe.

6. A method of operating a transmitter for use with a cellular communication network, comprising:
providing a reference signal corresponding to a reference signal structure for more than four transmit antennas;
providing a system information signal corresponding to the reference signal structure for the more than four transmit antennas; and
transmitting the reference signal and the system information signal.

7. The method as recited in claim 6 wherein the reference signal corresponds to one selected from the group consisting of:
a unicast subframe;
a multicast subframe; and
an advanced unicast subframe.

8. The method as recited in claim 6 wherein the reference signal distinguishes between a multicast subframe and an advanced unicast subframe.

9. The method as recited in claim 6 wherein the reference signal conforms to a reference signal structure that provides paring of select transmit antennas.

10. The method as recited in claim 6 wherein the system information signal provides an indication that distinguishes between a unicast subframe and a non-unicast subframe.

11. A receiver for use with a cellular communication network, comprising:
a receive unit configured to receive a reference signal and a system information signal;
a reference signal decoding unit configured to decode the reference signal based on a reference signal structure for more than four transmit antennas; and
a system information signal decoding unit configured to decode the system information signal based on the reference signal structure for the more than four transmit antennas.

12. The receiver as recited in claim 11 wherein the reference signal corresponds to one selected from the group consisting of:
a unicast subframe;
a multicast subframe; and
an advanced unicast subframe.

13. The receiver as recited in claim 11 wherein the reference signal distinguishes between a multicast subframe and an advanced unicast subframe.

14. The receiver as recited in claim 11 wherein the reference signal conforms to a reference signal structure that provides paring of select transmit antennas.

15. The receiver as recited in claim 11 wherein the system information signal provides an indication that distinguishes between a unicast subframe and a non-unicast subframe.

16. A method of operating a receiver for use with a cellular communication network, comprising:
receiving a reference signal and a system information signal;
decoding the reference signal based on a reference signal structure for more than four transmit antennas; and
decoding the system information signal based on the reference signal structure for the more than four transmit antennas.

17. The method as recited in claim 16 wherein the reference signal corresponds to one selected from the group consisting of:
a unicast subframe;
a multicast subframe; and
an advanced unicast subframe.

18. The method as recited in claim 16 wherein the reference signal distinguishes between a multicast subframe and an advanced unicast subframe.

19. The method as recited in claim 16 wherein the reference signal conforms to a reference signal structure that provides paring of select transmit antennas.

20. The method as recited in claim 16 wherein the system information signal provides an indication that distinguishes between a unicast subframe and a non-unicast subframe.
